(19) United States
(12) Patent Application Publication
(10) Pub. No.: US 2016/0358228 A1
(43) Pub. Date: Dec. 8, 2016

(54) COMPUTING SYSTEM THAT MANAGES PRESENTATION OF ELECTRONIC CONTENT

(71) Applicant: Microsoft Technology Licensing, LLC, Redmond, WA (US)

(72) Inventors: Eren MANAVOGLU, Menlo Park, CA (US); Bach Q. HA, Fremont, CA (US); Jie CAO, Bellevue, WA (US); Craig Ernst Boucher, Bellevue, WA (US); Patrick Richard Lloyd JORDAN, Mercer Island, WA (US)

(21) Appl. No.: 14/728,329

(22) Filed: Jun. 2, 2015

(51) Int. Cl. G06Q 30/02; G06F 17/30

(52) U.S. Cl. CPC G06Q 30/0275; G06F 17/3053; G06F 17/30867; G06F 17/30554

(57) ABSTRACT

A computing system can include an advertisement server that, as part of an auction for a paid search advertisement, calculates an original score for a particular bidder by using a scoring function; calculates an optimized score for the particular bidder by obtaining a score estimate from a system storing results of an offline historical model for the particular bidder, calculating a reserve price value by calculating δ(s*-ŝᵢ), and adding the reserve price value (which may be a negative value) to the original score; and assigns the particular bidder to a paid search advertisement slot according to the optimized score. The optimized score can be represented by the formula \tilde{s}ᵢ=sᵢ+δ(s*−ŝᵢ), where sᵢ is the original score, δ is a multiplier between 0 and 1, s* is a fixed point that may be equal to 0, and ŝᵢ is the score estimate for the bidder that comes from the offline historical model.

### BACKGROUND

Computing systems handling paid search advertising for search engines often employ generalized second-price (GSP) auctions or other sales and allocation mechanisms such as Vickrey-Clarke-Groves (VCG) and Core-selecting auctions (e.g., nearest-Vickrey, proxy, proportional, nearest-bid pricing rule), to sell online advertisements that are displayed along with search results on a page of links indicated as relevant to a particular search query. Despite the many technical advances that have improved not only internet-based searching for information, goods and/or services, but the paid search advertising that accompanies search results, a great number of technical challenges and problems remain. One of such problem involves determining how to allocate paid search result listings so as to maximize the perceived relevancy of the search results and optimize revenue while minimizing social cost to both the advertisers and those who are using the search engines to generate relevant results.

Most paid search advertising utilize pay-per-click schemes. It is well established that the presentation of an item listing in a search results page—for example, the order or placement of the item listing in a list of links—can affect whether someone selects, or “clicks through” the listing. Therefore, an advertiser may desire a particular placement and place a particular value on that placement. In addition to placement, the value of a particular listing to a particular advertiser is based on numerous attributes, including relevancy of the listing to a query of the search engine, likelihood that a sufficient number of people click through the link, as well as whether those that click through the advertisement link then complete a transaction at the advertiser's page. These considerations can also change over time, resulting in different bids and adjustments of the key words or terms selected for returning advertising links or other electronic content. From the search engine perspective, the value of a listing is the number of clicks of a link times the amount per click the advertiser is willing to spend. Identifying the amount per click to charge to maximize revenue can entail analyzing massive amounts of data.

Accordingly, the computing systems handling paid search advertising tend to involve distributed computing platforms and other configurations that support online processing of massive amounts of data.

### BRIEF SUMMARY

Computing systems and techniques for reducing processing complexity in high volume calculation systems are described. A modified scoring function is presented that, when used by a computing system, can achieve optimal results while minimizing the bandwidth and processing requirements for the computing system.

In one environment, a computing system can include an advertisement server that, as part of an auction for a paid search advertisement, calculates an optimized score for a particular electronic content of a particular bidder by obtaining a score estimate from a system storing results of an offline historical model for the particular bidder, calculating a reserve price value by taking a difference between a fixed point value and the score estimate and multiplying the difference by a multiplier value, and adding the reserve price value to an original score for the particular bidder generated by using a scoring function; and assigns the particular electronic content to the paid search advertisement according to the optimized score. The mechanisms for assigning the particular electronic content to the paid search advertisement can include allocations schemes such as GSP or VCG.

The optimized score can be represented by the formula \tilde{s}ᵢ=sᵢ+δ(s*−ŝᵢ), where sᵢ is a score obtained via any suitable scoring function, δ is a multiplier between 0 and 1, s* is a fixed point and may even be equal to 0, and ŝᵢ is a value that comes from the offline historical model. Advantageously, the addition of the three-parameter (δ, s*, and ŝᵢ) modification to a scoring function yields improved efficiencies in a paid search marketplace.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates part of an operating environment in which the described techniques are carried out.

FIGS. 2A and 2B illustrate processes that may be carried out by an online advertisement application.

FIG. 3 shows a block diagram illustrating components of a computing device or system used in some implementations of the described advertisement server.

### DETAILED DESCRIPTION

Win Systems and techniques for reducing processing complexity in high volume calculation systems are described that are suitable for servers and applications managing paid search advertising and the presentation of electronic content. A bidder-specific, modified scoring function in the form of \tilde{s}ᵢ=sᵢ+δ(s*−ŝᵢ) is provided for allocating content to particular locations on a page of results of a search query. Advantageously, the addition of the three-parameter (δ, s*, and ŝᵢ) modification to a scoring function yields improved efficiencies in a paid search marketplace. Certain embodiments of the systems and techniques described herein are directed to reducing use of computing resources while optimizing the revenue through use of a reserve price.

As used herein the terms “advertisement” and “ad” are used interchangeably. In addition to advertisements, the techniques described herein are suitable for other electronic content that is allocated and priced via a generalized second price auction mechanism, Vickrey-Clarke-Groves, Core-selecting auction mechanism, and the like.

As described above, GSP auctions or other sales and allocation mechanisms are used to sell online advertisements that are displayed along with search results on a page of links indicated as relevant to a particular search query. Electronic content submitted by advertisers are commonly scored and ranked via a linear function of the advertiser's bid. Thus, the scoring function for these scenarios is the linear function of the advertiser's bid. To increase revenue, some applications use auction density methods and complex scoring models. However, these techniques can consume significant resources.

According to certain implementations of the described techniques, instead of scoring ads via auction density methods and complex scoring models, the pricing and allocating of a paid search ad is performed using a modified scoring function encoding historical and contextual information of a value of a slot being sold. The modified scoring function can be given as \tilde{s}ᵢ=sᵢ+δ(s*−ŝᵢ), where sᵢ is a score obtained via any suitable scoring function, δ is a multiplier between 0 and 1, s* is a fixed point and may even be equal to 0, and ŝᵢ is a value that comes from an offline model. If the original score sᵢ is obtained from a scoring function such as some value q times the bid times e, the remaining formula, δ(s*-ŝᵢ), can be considered the reserve price. It should be noted that “δ(s*-ŝᵢ)” may be a negative number so that the modified score is a result of an original score minus reserve price (or original score plus a reserve price having a negative value). The described techniques may dramatically simplify the process of optimizing paid search marketplaces and may yield a more efficient solution than previous methods such as auction density methods and complex scoring models.

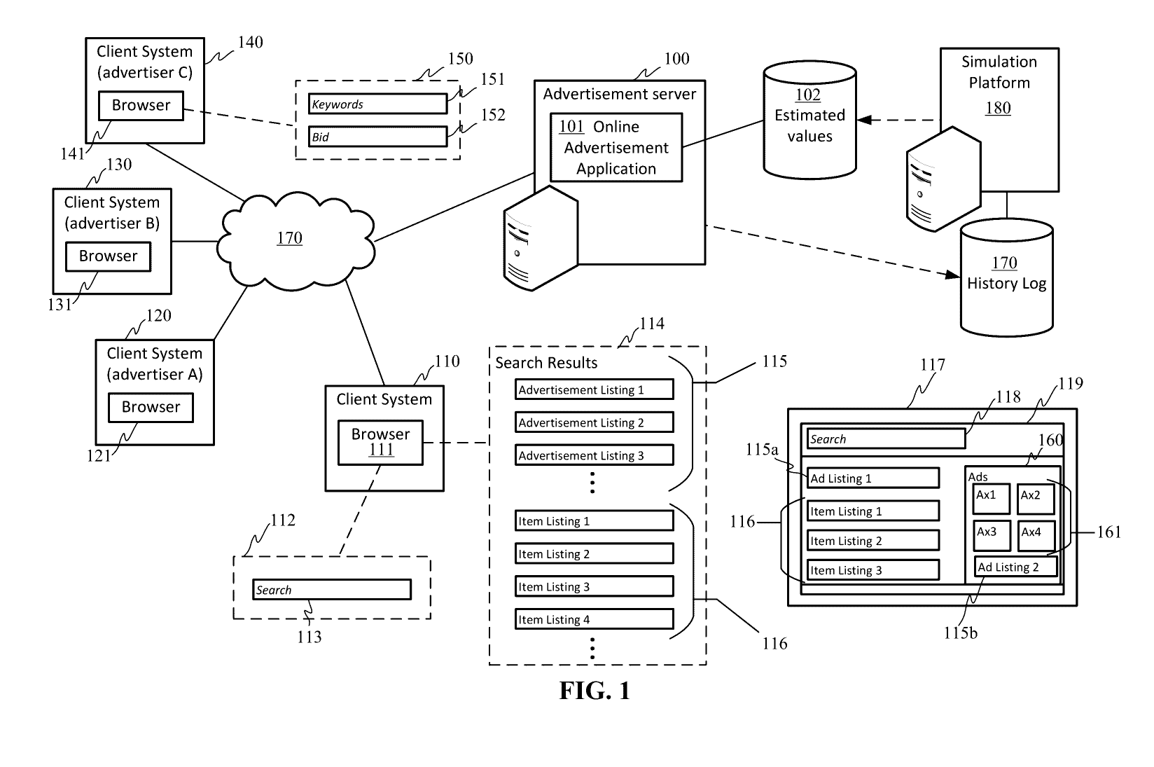

FIG. 1 illustrates part of an operating environment in which the described techniques are carried out. Referring to FIG. 1, an advertisement server 100 can include and execute an online advertisement application 101. In certain implementations, the advertisement server 100 can be part of or associated with a search engine. The online advertisement application 101 can, at the time the search engine is retrieving relevant results of a search query, determine the appropriate electronic content to be provided with the relevant results of the search query. The electronic content can be paid search results or other paid advertisements that are selected and ranked according to a modified scoring function.

The online advertisement application 101 identifies, using the key words from the search query input to the search engine, at least the electronic content indicated as desired to be associated with the key words, the corresponding source (advertiser), and their bid. These items may be stored in or across one or more resources (e.g., with storage) available to the advertisement server 100.

After identifying the electronic content using the key words from the search query, a modified scoring function is applied for each electronic content and the resulting optimized scores are used to assign the electronic content to a particular slot for paid advertisements. The modified scoring function applied by the online advertisement application 101 is specific to the particular source (advertiser) of the electronic content and uses an estimated value from an estimated values database 102 (or other data structure) stored on a resource (e.g., storage) that is accessible by the advertisement server 100. This storage may be one or more computer readable storage media that are part of the advertisement server 100 or some other associated virtual or non-virtual server. In some cases, the estimated value can be stored on a same resource as one or more of the electronic content, corresponding source and their bid. In some cases, the estimated value can be stored on an entirely separate resource or resources.

The online advertisement application 101 calculates a modified scoring function for each advertiser in order to carry out an auction-style assignment of electronic content to paid advertisement slots on a page of returned search results. The auction for a paid search advertisement can be a generalized second price auction. In such a case, an auction may use a scoring function to generate a score for each advertiser, which is then used to rank and assign advertising slots to the advertiser, for example using a greedy algorithm. The auction may alternatively be a VCG, Core-selecting, or other type of auction. In one such case, an auction may use a scoring function to generate a score for each advertiser and then perform a VCG-based algorithm to maximize the total score.

The scoring function can be any suitable scoring function. For example, the scoring function may be a linear function of the advertiser's bid. The linear function may be as simple as assigning a number equal to or based on the dollar amount of the bid from the particular bidder.

A simple example of the use of a score to assign advertisements to slots on a page is provided as follows. In an auction for paid search advertising, bids may be provided for similar key words by advertiser A, B, and C. FIG. 1 illustrates one example manner that this may be carried out. Here, the advertisers may input bids via an advertiser interface at any time, for example via system A 120 running browser 121, system B 130 running browser 131, and system C 140 running browser 141, where the browser (e.g., 141) can be used to navigate to an online portal of the advertisement server 100 or other server for the search engine providing an advertiser interface. In some cases, the advertiser interface 150 enables an advertiser to upload (or otherwise provide) electronic content, select bid amount(s) 152 (or other price limitation or indication), and select key words 151 to be associated with the electronic content. This information is maintained in a database (or other data structure) accessible by the advertisement server and used at the time a query is received by the search engine.

For example, a user, via client system 110 running browser 111, may enter a search query in a search field 112 of a search interface 111. The search field 112 may be an input field on a web page of the search engine, an address bar for the browser, or other mechanism that can provide search terms to the search engine (e.g., voice or gesture-based interfaces). When the search query is received, the search engine processes the query to identify key words, topics, entities, and the like so that relevant search results 114 of relevant listing content 116 can be returned to the user. The advertisement server 100 for the search engine provides the appropriate electronic content 115 for the paid advertisements so that they are included with the relevant listing content 116 of the search results 114 returned to the user.

There may be a certain number of relevant listing content 116 that can fit on a page 119 of search results provided in a view 117 displayed at the client device 110. In addition, there may be a certain number of slots and locations of slots in which paid advertisements and other electronic content may be displayed. For example, in the view 117, one advertisement listing 115a may be provided at the top of the item listing of relevant listing content 116 and other advertisements and electronic content may be provided at a side of the item listing, for example in an advertisement region 160 of the page. In the example advertisement region 160, a second (or more) advertisement listing 115b is displayed. In addition, electronic content 161 for where to purchase or obtain additional information can also be included (which can be a different form of paid advertising and/or selected from a different auction or type of selection). View 117 also shows a search field 118 for a user to enter or modify the search query, which could lead to updated or modified results being displayed in the view 117.

In addition to key words, the electronic content for the paid advertisements is assigned to an available slot for paid advertisements based on the particular algorithm applied. For GSP, in the case where the score is the amount indicated in the bid, each advertiser A, B, and C is ranked by the amount bid for that auction. If A bids $2, B bids $1, and C bids $0.50, A, B, and C would be ranked A-B-C. If there are three slots for paid advertisements on a page of returned search results, then it is possible that the electronic content of all three would be displayed to the user.

One way to maximize revenue from an auction is to set a reserve price. That way an advertiser must bid a certain amount in order to obtain a slot. For example, if there is a reserve price of $1 in the simple example described above, than C would not get a slot because they do not meet the reserve. This could be implemented as part of the auction rules. The concept of reserve price can be incorporated into the scoring function to maximize revenue.

Indeed, appropriate selection of the scoring function (and reserve price) can increase the revenue. The reserve price can be generated based on historical data from past auctions. In the environment illustrated in FIG. 1, historical data from activities at the advertisement server can be logged 170 and stored in an offline or cloud storage for later use. In general, to determine a reserve price and the market, trends and predictions can be identified from historical data. Here, logs of past auctions and bids such as stored in a history log 170 can be analyzed. To illustrate data collection, information about each of the auctions that take place for a search engine can be recorded. The data can be partitioned by query. For example, if a person searches for Nike tennis shoes, an analysis (via simulations) can be carried out to determine an optimal reserve price for a search query indicating a search for tennis shoes. Similarly, an optimal reserve price can be determined for people searching for mesothelioma.

This data can be recorded in such a way that it is possible to recover the state of the computer that ran the auction. For example, the data collection can entail segmenting the market by query terms; having a set of parameters for each query; and taking logs to store this information. Then, using distributed computation, it is possible to figure out what would have happened if something (one of the parameters) was changed. These simulations entail large amounts of processing power. Since online processing of such simulations or optimizations would require high bandwidth (for parallel processing) or a significant amount of time (such that there could be an undue delay for returning search results and therefore user dissatisfaction), embodiments of the described techniques perform analyses on the historical data (from history log 170) on an offline simulation platform 180.

The offline simulation platform 180 can execute an optimization algorithm on the data collected for a specified period of time in the history log 170. For example, a three month period of time can be analyzed to set reserve prices. The data can be reviewed auction by auction for real data and simulations can be carried out to go back to see what would happen if certain things were changed.

To illustrate a computation that may occur, the historical log, taken over the example period of 3 months, can be partitioned by query clusters (sets of related queries). For each query cluster, a parameter is set—here a reserve price. There may be thousands or hundreds of thousands to set. If the objective is then to optimize the reserve prices for each auction (and advertiser), there is a tremendous amount of data to be held and computing resources to process/optimize the millions of choices. Since all of this can be carried out offline on the simulation platform 180, the online advertisement application 101 does not have to consume the computing resources. Instead, results of the offline historical model generated by the simulations run on the simulation platform 180 using data collected over a specified period of time (or within certain dates) can be stored as estimated values 102 associated with a particular advertiser (and in some cases, the particular key words associated with the advertiser's electronic content).

The system storing results of the offline historical model (e.g., the estimated values 102) can be part of or accessed by the computing system. The results of the offline historical model may be maintained in a database, table, or other data structure that enables the computing system to obtain a stored score estimate for the particular bidder (and the key words associated with the paid search advertisement for which the auction is being carried out).

According to an implementation, the ultimate scoring function applied for a bid can be individualized for advertiser/bidder. Therefore, instead of a general reserve price for all advertisers, a reserve price can be set based on features of a particular advertiser. To accomplish this task, an estimate of what an ad's value is to a particular advertiser is determined as part of the offline simulation and stored as ŝᵢ in a structured format such as a database.

The offline model may be any suitable offline model capable of generating a score estimate. For example, simulations can be performed using historical data for the particular bidder. Where the particular bidder has not bid before or there is insufficient historical data, the particular bidder can be determined to fall within a certain class of bidders and data for that class used in the offline model until a sufficient amount of historical data is collected.

Accordingly, real-time (e.g., in response to receiving a search query via a search engine), the advertisement server 100, executing the online advertisement application 101, calculates an original score for a particular bidder by using a scoring function; calculates an updated score for the particular bidder by requesting a score estimate from a system storing results of an offline historical model for the particular bidder, calculating a reserve price value by taking a difference between a fixed point value and the score estimate and multiplying the difference by a multiplier value, and adding the reserve price value to the original score; and assigns the particular bidder to the paid search advertisement according to the updated score (and allocation algorithm selected).

It is not necessary to process all of the available parameters to calculate an estimated value. Instead an advertiser value model is created offline and used, through some function of advertiser value, to set a reserve price. Computational savings can be achieved since now a single pass can be taken through the data and associated as part of the model offline. The optimal reserve price can then be easily determined online.

In one implementation, the value of a particular slot to an advertiser can be considered to be estimated by a bid since it can be assumed that a bid is proportional to the value (e.g., the amount bid is equivalent to value). By looking at historical data for the amount of the closest competitor (e.g., the next highest bid to that advertiser) in historical auctions (e.g., all of the auctions for which a particular advertisement was intended to be displayed over a particular period of time), it can be possible to estimate the value of a bid to the advertiser and this model can go into the assumption. That is, an assumed value can be estimated as part of the model by, for each ad in the market place, identifying the amount of the bidder closest to the advertiser for that ad.

Advantageously, through this model, it is possible to come up with a value that is independent of other advertisers and does not depend on another model (or estimates). This model is simple to construct since the predicted value does not have to depend on the prediction of other values. Rather this model takes into consideration just the data regarding the ads and corresponding closest competitor's bid for a certain period of time. The average of the value of the closest competitor's bid over the certain period of time can be used as the prediction for the value of the bid.

Other examples of computing the value offline include, but are not limited to, using a combination of features such as bid, query, competitor's bids, number of competitors (also referred to as the thickness of the market), ad relevance, probability of a click, and probability of a defect.

In some implementations, the original score s, has the form of some value q (quantity) times bid amount times e (the expected payment/cost to the advertiser). In a second price auction (and in some other auctions), prices increase when relative scores are closer together. If all scores are converted closer to fixed point (s*), then prices start to increase. The fixed point value is a parameter and may be 0 in some cases. The multiplier value can be a value between 0 and 1. Thus, with four “variables”, the updated score can easily be calculated online and with minimal resources to appropriately assign the advertisements to the page of results of a search query.

Advantageously, implementations of the described formula decomposes the problem of identifying an appropriate reserve price without having to worry about the hundreds of thousands of parameters that go into identifying an optimized value for an advertisement slot. It is possible to construct a model where the value of a particular ad is estimated for an advertiser. This estimate can then show up in the auction and be used to set the reserve price. Since an estimated value is used to set the reserve price in this manner, there is no need to—at the time of the auction (which may be carried out at the time a particular query is received by a search engine)—run an optimization algorithm on hundreds of thousands of free parameters for a cluster and consume a lot of computational resources.

The described formula presents a simple model that can be used online to achieve an optimal reserve price. The requirement of performing the optimization algorithms and massive clustering over a distributed set of machines over terabytes of data to achieve an optimal reserve price can be removed from the online computations. Instead, offline simulations may be carried out at determined times (and using a determined period of historical data) and the results of those simulations can be an estimated value. Then, by using the described formula, it is possible to on-the-fly (real time) identify the optimal reserve prices using the estimated value.

The business of paid search advertising focuses, in part, on optimizing the financial returns of selling advertisements based on key words entered by a user (directly or indirectly) as part of a search query. In paid search advertising, advertisers target their ads based on search keywords. Search engines are often paid according to a “pay-per-click” pricing scheme where the advertiser pays the search engine for sending a user to a particular Web page when the user clicks on the advertisement. Because the number of ads that the search engine can show to a user is limited and where the ad is positioned on the page may result in more or fewer clicks, maximizing revenue from selling the paid advertisements (or “sponsored links”) involves properly allocating the “slots” (the multiple positions in which an ad may appear) for the advertisers. That is, a search engine determines which ads to place where and the price per click for each slot.

To optimize the financial returns for the search engine while still maintaining attractive rates for the advertisers, second price auctions (e.g., GSP auctions), modified VSG auctions, as well as other mechanisms, have come into popularity.

A GSP auction is a non-truthful auction mechanism for multiple items. Each bidder places a bid. The highest bidder gets the first slot, the second-highest bidder gets the second slot and so on (a greedy algorithm), where the highest bidder pays the price bid by the second-highest bidder, the second-highest bidder pays the price bid by the third-highest bidder, and so on. A common application for GSP auctions is in the context of keyword auctions, where advertisers can bid for sponsored search slots that are returned when a user inputs a query containing certain keywords in a search engine.

As an illustrative example, in a GSP auction associated with a specific keyword, advertisers submit bids stating their maximum willingness to pay for a click. The search engine then would, in response to receiving a search query containing the specific keyword, provide, as part of the search results to the user, sponsored links for those advertisers in decreasing order of bids. The cost to the advertiser is then based on the price of the next highest bid.

The use of a reserve price, such as available through the described formula and optimized scoring function, can ensure that the auction generates revenue. The described techniques incorporate the concept of a reserve price, but the value is dependent on the source of the bid (the company or entity submitting the bid).

As an illustrative example, there are two available slots and three bidders A, B, and C, where A bids $5, B bids $2, and C bids $1. Since the value of the described formula can be dependent on the source of the bid, the reserve price can be different for each bidder, for example $2 for A, $1 for B, and $0.5 for C. This results in optimized scores of $3 for A, $1 for B, and $0.50 for C.

For a GSP-like auction, A and B win the auction with scores of 3 and 1. A pays $1 and B pays $0.5 (where payment is equal to the next closest bidder's bid). For a VCG-like auction, A and B win the auction with a combined total of $4. A pays $0.50 and B pays $0.50 (where payment is total bids of other bidders that would have won if that bidder did not participate minus the total bids of the other actual winning bidders).

As another illustrative example, A has a score of 2 (from some scoring function modified with the described formula) to occupy one line, B has a score of 3 (from the modified scoring function) to occupy one line, and C has a score of 4 (from the modified scoring function) to occupy two lines. Given a rule that no more than two lines are allocated (e.g., there are only two available slots), a GSP mechanism would select C for the two lines since C has the highest score whereas the VCG mechanism would select A and B to allocate to the two lines to maximize the total scores (2+3=5>4).

Optimizing the revenue from a particular auction may be carried out by identifying the appropriate reserve price and identifying a value of a particular click to a specific advertiser. Advertisers bidding for slots can change their bids over time; this data can be stored in historical logs for later adjustment to the offline model as well as affect the real-time calculations of the score.

In this manner, the estimated value from the offline model can be advertiser specific and based on historical information about a slot and an advertiser. A table or other data structure may be used to store the estimated value and when a bid comes in to the system (e.g., via interface 150) or at the time a request to fill out a page with paid search advertisements, a look-up can be performed using the table of estimated values and either “stamped” on the advertisement or immediately used in a calculation. This estimated value can be used to create a reserve price. The advertiser is then given a score based on what would have been the score for the advertiser's bid according to the bid itself minus a reserve price that is not a static reserve price, but rather based on that advertiser's history. This modified scoring function (and optimized score) can be used to allocate (or “assign”) electronic content to the available slots on the page.

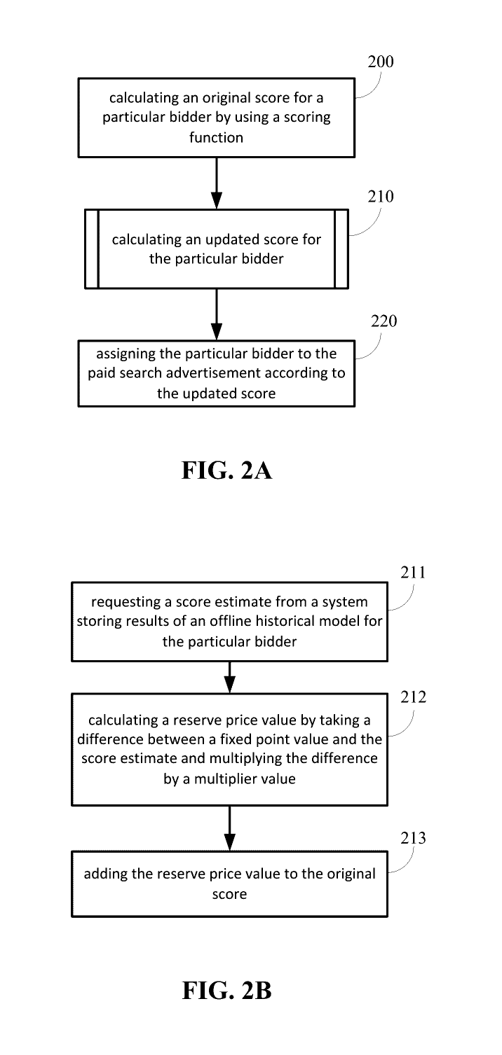

FIGS. 2A and 2B illustrate processes that may be carried out by an online advertisement application. Referring to FIG. 2A, an optimized score (Sᵢ) can be calculated immediately before assigning particular advertisements (or other electronic content) to an available slot in response to receiving a search query at a search engine. First, the system (e.g., advertisement server 100) calculates an original score sᵢ for a particular bidder identified by the key words of the search query (200). In some cases, the online advertisement application 101 includes instructions for performing this calculation. In other cases, the online advertisement application 101 receives the original score value from another software module available to the advertisement server 100. In either case, the online advertisement application 101 directs the system to calculate an updated score for each of the particular bidders identified by the key words of the search query (210). This may be accomplished by appending the modifier of δ(s*-ŝᵢ) to the original score sᵢ.

For example, as shown in FIG. 2B, the updated score can be calculated by requesting a score estimate for the particular bidder from a system storing results of an offline historical model (211). A reserve price is then calculated by taking a difference between a fixed point value s* and the score estimate Sᵢ and then multiplying the difference by a multiplier value δ(212). Of course, in some cases, the multiplier value may be applied to the fixed point value and the score estimate before the difference is taken. Finally, the “reserve price” represented by the modifier δ(s*-ŝᵢ) is added to the original score (213) to generate the optimized score \tilde{s}ᵢ. Often the modifier is a negative value, resulting in what can be understood as the original score minus the reserve price.

After calculating the updated score, the particular bidder can be assigned to the paid search advertisement slot according to the updated score (220). The online advertisement application 101, when implementing a GSP or GSP-like approach, can sort all the ads by the optimized score \tilde{s}ᵢ , and then can use the sorted order and the \tilde{s}ᵢ to determine a price. For example, in a GSP auction, the highest ranked bidder is assigned a price per click based on the next highest bidder's optimized score, and so on. The online advertisement application 101, when implementing a VCG or VCG-like approach, can determine a maximum score based on the bidders optimized scores.

Depending on the rules of the auction (e.g., whether the score must be positive), some bidders may not be assigned to a paid search advertisement. Ultimately, as these steps are all carried out online, the particular bidders can be assigned to the paid search advertisement slots on a page of search results according to the updated score using a minimal amount of resources.

The bidding may be received by the system at various times—not related to when search queries are received. As part of the pay per position auction, it may not be possible to actually look at the bids. Indeed, the model used by the online advertisement application 101 does not have to look at the bids. Instead, there is a prediction of the score (in the form of ŝᵢ) based on an offline model. The modifier (which includes the prediction of the score ŝᵢ) is appended to the original score and can be processed through standard calculations, eliminating the need for the hundreds of thousands of parameters.

The described calculations not only reduces the number of resources, but also can result in improved values because it is possible to map the value into an optimal reserve price. The offline model just generates a component of ŝᵢ. Prior to the online system receiving bids, the separate database generates a model. That way when an ad comes to the system, the value (e.g., ŝᵢ) of that model can get “stamped” on the ad (e.g., associated with the bidder/source and ad in some fashion in the database or other information structure used to store the ad).

That is, according to certain implementations, separate from the auctions (which may be occurring real-time), historical data is analyzed offline to generate the model ŝᵢ, which gets stored in a database. When a request to fill out a page (with paid search results) is received by the advertisement server 100, the ads that match some criteria for that auction get pulled out of the database. This information is stamped on to the set of information known about the ad and can be used to generate \tilde{s}ᵢ in the online system.

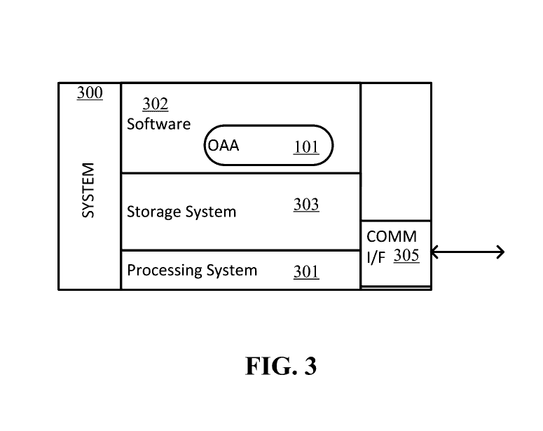

FIG. 3 shows a block diagram illustrating components of a computing device or system used in some implementations of the described advertisement server. For example, any computing device operative to run at least an online advertisement application 101 may be implemented as described with respect to system 300, which can itself include one or more computing devices. The system 300 can include one or more blade server devices, standalone server devices, personal computers, routers, hubs, switches, bridges, firewall devices, intrusion detection devices, mainframe computers, network-attached storage devices, and other types of computing devices. The hardware can be configured according to any suitable computer architectures such as a Symmetric Multi-Processing (SMP) architecture or a Non-Uniform Memory Access (NUMA) architecture.

The system 300 can include a processing system 301, which may include a processing device such as a central processing unit (CPU) or microprocessor and other circuitry that retrieves and executes software 302 from storage system 303. Processing system 301 may be implemented within a single processing device but may also be distributed across multiple processing devices or sub-systems that cooperate in executing program instructions.

Examples of processing system 301 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 303 may comprise any computer readable storage media readable by processing system 301 and capable of storing software 302 including online advertisement application 101 (and/or execute instructions directing the processing system 301 to perform the steps described with respect to FIGS. 2A and 2B). Storage system 303 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic disks, optical disks, CDs, DVDs, flash memory, solid state memory, phase change memory, or any other suitable storage media. Certain implementations may involve either or both virtual memory and non-virtual memory. In no case do storage media consist of a propagated signal. In addition to storage media, in some implementations, storage system 303 may also include communication media over which software 302 may be communicated internally or externally.

Storage system 303 may be implemented as a single storage device but may also be implemented across multiple storage devices or sub-systems co-located or distributed relative to each other. Storage system 303 may include additional elements, such as a controller, capable of communicating with processing system 301.

Software 302 may be implemented in program instructions and among other functions may, when executed by system 300 in general or processing system 301 in particular, direct system 300 or processing system 301 to operate as described herein for reducing processing complexity in high volume calculation systems suitable for servers and applications managing paid search advertising and the presentation of electronic content. Software 302 may provide program instructions that implement an online advertisement application 101, search engine components, and/or subcomponents thereof. Software 302 may implement on system 300 components, programs, agents, or layers that implement in machine-readable processing instructions the methods described herein.

Software 302 may also include additional processes, programs, or components, such as operating system software, database management software, or other application software. Software 302 may also include firmware or some other form of machine-readable processing instructions executable by processing system 301.

In general, software 302 may, when loaded into processing system 301 and executed, transform system 300 overall from a general-purpose computing system into a special-purpose computing system customized to optimize and manage paid search advertising. Indeed, encoding software 302 on storage system 303 may transform the physical structure of storage system 303. The specific transformation of the physical structure may depend on various factors in different implementations of this description. Examples of such factors may include, but are not limited to, the technology used to implement the storage media of storage system 303 and whether the computer-storage media are characterized as primary or secondary storage.

System 300 may represent any computing system on which software 302 may be staged and from where software 302 may be distributed, transported, downloaded, or otherwise provided to yet another computing system for deployment and execution, or yet additional distribution.

In embodiments where the system 300 includes multiple computing devices, one or more communications networks may be used to facilitate communication among the computing devices. For example, the one or more communications networks can include a local, wide area, or ad hoc network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 305 may be included, providing communication connections and devices that allow for communication between system 300 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

Alternatively, or in addition, the functionality, methods and processes described herein can be implemented, at least in part, by one or more hardware modules (or logic components). These elements may include, but are not limited to, the processing system 301, a communications interface 305, and even elements of the storage system 303 and software 302. For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system for managing presentation of electronic content, comprising:
a processing system;
a storage system; and
instructions stored on the storage system that when executed by the processing system direct the processing system to:
in response to receiving a request for electronic content for a page of search results:
obtain an original score for a particular electronic content meeting a criteria for the page of search results,
obtain a score estimate value for the particular electronic content,
calculate a modifier using a formula of δ(s*-ŝᵢ), where δ is a multiplier between 0 and 1, s* is a fixed point value equal to or greater than 0, and ŝᵢ is the score estimate value, and
calculate an optimized score for the particular electronic content by adding the modifier of to the original score for the particular electronic content; and
assign appropriate ones of the particular electronic contents to available slots for the page of search results based on the optimized score for the particular electronic contents.

2. The system of claim 1, further comprising:
a value estimate storage system storing the score estimate values, wherein the instructions that direct the processing system to obtain the score estimate value for the particular electronic content direct the processing system to retrieve the score estimate value from the value estimate storage system.

3. The system of claim 2, wherein the score estimate value for the particular electronic content is associated with the particular electronic content in the value estimate storage system in response to receiving the particular electronic content from a source of the particular electronic content.

4. The system of claim 2, further comprising:
a history storage system; and
an offline simulation platform having instructions stored thereon that when executed direct the offline simulation platform to retrieve historical data from the history storage system to generate the estimated values from a model, and store the estimated values at the value estimate storage system.

5. The system of claim 1, wherein the instructions that direct the processing system to assign the appropriate ones of the particular electronic contents to the available slots direct the processing system to:
rank the electronic content meeting the criteria for the page of search results according to the optimized score for each of the particular electronic contents; and
provide an appropriate one of the electronic content meeting the criteria for presentation in each available slot for the page of search results using a rank order of the electronic content.

6. The system of claim 1, further comprising:
a search engine application stored on the storage system that when executed by the processing system directs the processing system to, in response to receiving a search query, at least generate the request for electronic content for the page of search results.

7. The system of claim 1, wherein the instructions that direct the processing system to obtain the original score comprise instructions to look up a bid value associated with the particular electronic content in a content storage; and calculate the original score according to the bid value associated with the particular electronic content.

8. The system of claim 7, wherein the instructions further direct the processing system to in response to receiving an updated bid value for the particular electronic content, store the updated bid value associated with the particular electronic content in the content storage.

9. The system of claim 1, wherein the instructions further direct the processing system to in response to receiving a bid value for the particular electronic content, calculate the original score and store the original score associated with the particular electronic content in a content storage, wherein the instructions that direct the processing system to obtain the original score comprise instructions to look up the original score associated with the particular electronic content in the content storage.

10. A method of reducing processing complexity in high volume calculation systems managing paid search advertising and presentation of electronic content, the method comprising:
receiving at least one key term from a query to a search engine;
identifying, from a data structure, electronic content associated with the at least one key term and obtaining a score estimate value and an original score associated with each of the identified electronic content associated with the at least one key term;
calculating an optimized score for each of the identified electronic content using a modified scoring function, the modified scoring function having a formula of \tilde{s}ᵢ=sᵢ+δ(s*−ŝᵢ) where \tilde{s}ᵢ is the modified scoring function, sᵢ is the original score; δ is a multiplier between 0 and 1; s* is a fixed value greater than or equal to 0, and ŝᵢ is a score estimate value generated by an offline model;
ranking the identified electronic contents according to their scores to determine a ranking order; and
providing the electronic contents that meet a threshold criteria for presentation on a page with search results.

11. The method of claim 10, further comprising:
receiving a particular electronic content, an indication of one or more key terms to associate with the particular electronic content, and a bid value for the particular electronic content;
calculating the original score based on the bid value; and
storing the original score in association with the particular electronic content and the one or more key terms to associate with the particular electronic content.

12. The method of claim 10, further comprising:
receiving a request for electronic content for a page of search results, the request indicating criteria including the at least one key term from the query to the search engine,
wherein the optimized score (Sᵢ) is calculated in response to receiving the request for electronic content for a page of search results.

13. The method of claim 11, further comprising:
associating the score estimate value with the particular electronic content after receiving the particular electronic content.

14. The method of claim 11, further comprising:
receiving an updated bid value for the particular electronic content;
calculating an updated original score based on the updated bid value;
storing the updated original score as the original score in association with the particular electronic content and the one or more key terms to associate with the particular electronic content; and
receiving a request for electronic content for a page of search results, the request indicating criteria including the at least one key term from the query to the search engine,
wherein the optimized score (Sᵢ) is calculated in response to receiving the request for electronic content for a page of search results.

15. One or more computer readable storage media having instructions for an online advertisement application stored thereon that when executed by a processing system, direct the processing system to:
obtain a set of electronic contents associated with one or more key words of a search query;
calculate an original score sᵢ for each particular electronic content in the set of electronic contents;
obtain a score estimate ŝᵢ for the particular electronic content from a system storing results of an offline historical model for the particular electronic content, the offline historical model being specific to a source of the particular electronic content;
calculate an optimized score for the particular electronic content by appending a modifier of δ(s*-ŝᵢ) to the original score sᵢ, wherein δ is a multiplier between 0 and 1 and s* is a fixed value equal to or greater than 0; and
provide appropriate ones from the set of electronic contents based on the optimized scores.

16. The media of claim 15, wherein the instructions for the online advertisement application further direct the processing system to:
sort the electronic contents in a rank order according to the optimized score of each particular electronic content, wherein the appropriate ones consist of the particular electronic content meeting a threshold criteria including the rank order.

17. The media of claim 15, further comprising instructions that direct the processing system to determine a price associated with a click through of each of the appropriate ones using the rank order and the optimized score.

18. The media of claim 15, further comprising instructions that direct the processing system to update the original score for the particular electronic content in response to receiving an updated bid for the particular electronic content.

19. The media of claim 15, wherein the instructions to obtain the set of electronic contents associated with the one or more key words of the search query, direct the processing system to:
identify, from a data structure, the electronic contents associated with the one or more key words.

20. The media of claim 15, wherein the processing system is directed to obtain the set of electronic contents associated with the one or more key words of the search query in response to receiving a request for electronic content for a page of search results, the appropriate ones being provided for presentation on the page of search results.
